(19) United States
(12) Patent Application Publication
(10) Pub. No.: US 2020/0210140 A1
(43) Pub. Date: Jul. 2, 2020

(54) RADIO GATEWAY AUDIO PORT CONFIGURATION

(71) Applicant: Cubic Corporation, San Diego, CA (US)

(72) Inventors: Stephen Wilson, Shackleford (GB); Estelle Tidey, Shackleford (GB)

(73) Assignee: Cubic Corporation, San Diego, CA (US)

(21) Appl. No.: 16/719,454

(22) Filed: Dec. 18, 2019

Related U.S. Application Data
(60) Provisional application No. 62/786,190, filed on Dec. 28, 2018.

(51) Int. Cl. G06F 3/16; H04R 29/00; H04M 1/253; H04W 88/16; G10L 25/78; H04W 4/10; H04W 52/52; H04W 92/20

(52) U.S. Cl. CPC G06F 3/165; H04R 29/008; H04M 1/2535; H04W 88/16; H04R 2430/01; H04W 4/10; H04W 52/52; H04W 92/20; G10L 2025/783; G10L 25/78

(57) ABSTRACT

A Radio Over Internet Protocol (RoIP) device can be configured to provide automatic determination of input gain, output gain, external power, and COR signaling settings for an audio port via a guided step-by-step user experience. According to some embodiments, input settings can be calculated based on the user speaking into the device and output settings are configured by the user adjusting the volume of predetermined audio being played. According to some embodiments, users can then label the settings, so that they can be copied to other audio ports using the same type of radio. Among other things, the embodiments provided herein increase the speed and ease with which the optimum audio port settings can be configured on a RoIP gateway device

### CROSS-REFERENCES TO RELATED APPLICATIONS

This application is a nonprovisional of and claims the benefit of priority to U.S. Provisional Patent Application No. 62/786,190, filed Dec. 28, 2018, entitled “RADIO GATEWAY AUDIO PORT CONFIGURATION,” the entire contents of which are herein incorporated by reference.

### BACKGROUND

RoIP is a technology that allows two-way radio communication between different radio and other communication platforms. Similar to Voice over IP (VoIP), RoIP can be deployed over private and/or public data communication networks (e.g., the Internet), which may utilize any of a variety of wired and/or wireless technologies (in addition to radio technologies utilized between radio handsets). Unlike VoIP, however, RoIP may additionally enable push-to-talk (PTT) functionality. Communications may be half- or full-duplex, depending on desired functionality and the capabilities of the various components of a RoIP system. Because RoIP uses a data communication network backbone to bridge various radio platforms, it can not only enable radio handsets to communicate with other types of radio handsets (e.g., radio handsets utilizing different frequencies), but it can also enable radio handsets to communicate with other types of non-radio devices, which may be far beyond the reach of a radio signal. With this functionality, RoIP can be extremely useful to first responders and others who frequently communicate using radios.

A RoIP gateway device (also referred to herein as a radio gateway) is a device that connects one or more radio networks to the RoIP system. Traditional techniques of setting up a RoIP gateway device may involve using physical switches or adjusting various software parameters. Because of the technical difficulty involved, set up of a radio gateway often requires technical expertise, and may be time-consuming to both determine and implement the correct settings.

### BRIEF SUMMARY

Embodiments disclosed herein address these and other issues by providing for automatic determination of input gain, output gain, external (mic) power, and COR signaling settings for an audio port of a RoIP gateway device via a guided step-by-step user experience. According to some embodiments, input settings can be calculated based on the user speaking into the device and output settings are configured by the user adjusting the volume of predetermined audio being played. According to some embodiments, users can then label the settings, so that they can be copied to other audio ports using the same type of radio. Among other things, the embodiments provided herein increase the speed and ease with which the optimum audio port settings can be configured on a RoIP gateway device.

An example method of configuring an audio port for a RoIP gateway device, according to the description, comprises providing, with the RoIP gateway device, a Graphical User Interface (GUI), and enabling, via the GUI, a test of input signals received at the audio port from a donor radio. The test of the input signals comprises a determination of whether a volume of input audio exceeds a threshold. The method further comprises enabling, via the GUI, a test of output signals provided at the audio port to the donor radio, wherein the test of the output signals comprises sending a predetermined audio output to the donor radio via the audio port, and adjusting audio settings of the audio port, wherein adjusting the audio settings comprises adjusting an input audio gain for the audio port based on results of the test of the input signals, adjusting an output audio gain for the audio port, or both.

An example RoIP gateway device, according to the description, comprises a memory, an audio port configured to be communicatively coupled with a donor radio, and one or more processors communicatively coupled with the memory and the audio port. The one or more processors are configured to provide a Graphical User Interface (GUI), and enable, via the GUI, a test of input signals received at the audio port from the donor radio, wherein the test of the input signals comprises a determination of whether a volume of input audio exceeds a threshold. The one or more processors are also configured to enable, via the GUI, a test of output signals provided at the audio port to the donor radio, wherein the test of the output signals comprises sending a predetermined audio output to the donor radio via the audio port. The one or more processors are also configured to adjust audio settings of the audio port, wherein adjusting the audio settings comprises adjusting an input audio gain for the audio port based on results of the test of the input signals, adjusting an output audio gain for the audio port, or both.

An example non-transitory computer-readable medium, according to the description, comprises instructions embedded thereon for configuring an audio port for a Radio over Internet Protocol (RoIP) gateway device. The instructions, when executed by one or more processors, cause the one or more processors to provide a Graphical User Interface (GUI), and enable, via the GUI, a test of input signals received at the audio port from a donor radio, wherein the test of the input signals comprises a determination of whether a volume of input audio exceeds a threshold. The instructions, when executed by one or more processors, further cause the one or more processors to enable, via the GUI, a test of output signals provided at the audio port to the donor radio, wherein the test of the output signals comprises sending a predetermined audio output to the donor radio via the audio port, and adjust audio settings of the audio port. Adjusting the audio settings comprises adjust an input audio gain for the audio port based on results of the test of the input signals, adjust an output audio gain for the audio port, or both.

### BRIEF DESCRIPTION OF THE DRAWINGS

For a more complete understanding of this invention, reference is now made to the following detailed description of the embodiments as illustrated in the accompanying drawings, in which like reference designations represent like features throughout the several views and wherein:

FIG. 1 is a simplified diagram of a RoIP system, according to an embodiment;

FIG. 2 is a flow chart of a set up process that can be executed by a RoIP gateway device to set up an audio port for use with a donor radio, according to an embodiment;

FIGS. 3-10 are illustrations of example GUI screens that can be provided by the RoIP gateway device during the setup process for the audio port, according to some embodiments;

FIG. 11 is a flow diagram of a method of configuring an audio port for a RoIP gateway device 110, according to an embodiment; and

FIG. 12 is a block diagram of simplified computer system, according to some embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any or all of the similar components having the same first reference label irrespective of the second reference label.

### DETAILED DESCRIPTION

The ensuing description provides embodiments only, and is not intended to limit the scope, applicability or configuration of the disclosure. Rather, the ensuing description of the embodiments will provide those skilled in the art with an enabling description for implementing an embodiment. It is understood that various changes may be made in the function and arrangement of elements without departing from the scope.

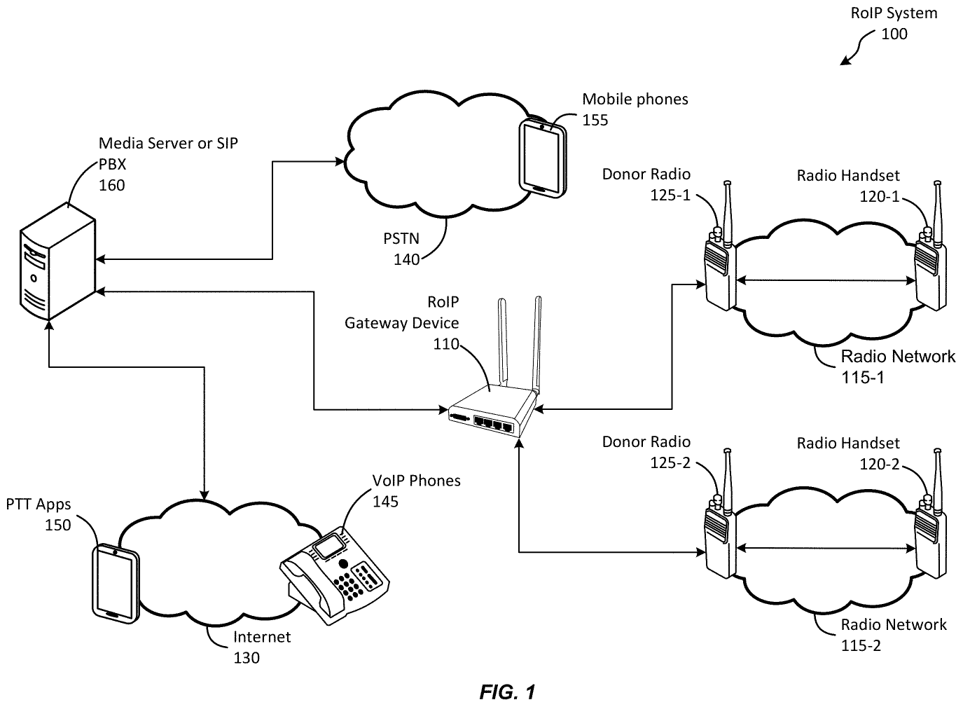

FIG. 1 is a simplified diagram of a RoIP system 100, according to an embodiment. Here, a RoIP gateway device 110, can operate to provide communications between various different components of the RoIP system 100. It will be understood that the various components provided in FIG. 1 are provided as examples. A RoIP system 100 may have more or fewer components, including any number of radio handsets 120 and/or other connected devices (VoIP phones 145, mobile phones 155, etc.). Moreover, the RoIP system 100 may have different types of connected devices than those shown.

Two different radio networks 115-1 and 115-2 (collectively and generically referred to herein as radio networks 115), which may utilize different radio platforms (different manufacturers, protocols, frequencies, etc.). Thus, a radio handset 120-1 of a first radio network 115-1 may not be able to communicate directly with a radio handset 120-2 of a second radio network 115-2. The RoIP gateway device 110, however, can enable these radios 120 to communicate by acting as an intermediary. To do so, each radio network 115 can include a respective “donor radio” 125-1 and 125-2 (collectively and generically referred to herein as donor radios 125) that can both communicate with radio handsets 120 of the respective radio network 115, and also communicate with the RoIP gateway device 110 via a connection to a respective one of several audio ports of the RoIP gateway device 110, which can communicate audio and other signals with a donor radio 125 connected therewith. (According to some embodiments, these audio ports may comprise RJ45 ports.)

Data communicated between the RoIP gateway device 110 and donor radios 125 may vary, depending on desired functionality. In addition to audio (both transmit and receive), data can also include PTT and (Carrier Operated Relay) COR signaling, which can enable the PTT functionality. According to some embodiments, a custom cable may be used to connect an interface of each donor radio 125 (e.g., an ear piece jack) to an audio port of the RoIP gateway device 110.

To enable the radio handsets 120 to communicate to other types of devices and/or remote radio networks (not shown) the RoIP gateway device 110 can be coupled with a media server or Session Initiation Protocol (SIP) Private branch Exchange (PBX) 160 as illustrated. The media server or SIP PBX 160 can enable radio handsets 120 to communicate with Internet-connected devices via the Internet 130 (e.g., PTT apps 150 and VoIP phones 145), and/or devices connected to a public switched telephone network (PSTN) 140 (e.g., mobile phones 155).

To ensure effective communications between radio handsets 120 and other devices of the RoIP system 100, it is important that the configuration of the audio port is correct. This is particularly important where mission critical communications are involved, such as emergency services, military operations, etc. If the parameters are configured too low, processes such as voice activity detection will not be triggered, and if too high, the voice quality will be distorted and not be understood. These settings will be dependent on the donor radio 125 connected to the audio port, therefore settings are configured on a per-port basis.

As noted, traditional techniques for configuring audio ports of a RoIP gateway device 110 were achieved through physical switches or via adjusting various software parameters. These techniques require a lot of time to both determine and implement the correct settings.

To address these and other issues, embodiments of a RoIP gateway device 110 can be configured to provide a graphical user interface (GUI) to guide the user through the audio port setup process, conducting audio tests of both input and output signals for proper setup. The results of the audio tests can then be used to facilitate the configuration of the audio port. The GUI of the RoIP gateway device 110 may be a webpage accessible via a browser, and therefore may be accessible via an electronic device (e.g., mobile phone, laptop, personal computer, tablet, etc.) communicatively coupled with the RoIP gateway device 110. In some embodiments, the RoIP gateway device 110 may be capable of connecting directly with a monitor and/or input devices (e.g., keyboard, mouse, etc.) for providing user access to the GUI. Using the techniques described herein, the GUI of the RoIP gateway device 110 allow a user to configure settings for audio ports of the RoIP gateway device 110 itself, in addition to audio ports of any expansion devices connected thereto.

The embodiments described herein can significantly improve the speed and ease with which the optimum audio port settings can be configured on a RoIP gateway device 110. Specifically, input gain, output gain, external power, and COR signaling settings can be automatically determined by the RoIP gateway device 110 via a guided step-by-step user experience. According to some embodiments, input settings can be calculated based on the user speaking into the device and output settings are configured by the user adjusting the volume of a voice recording being played. According to some embodiments, users can save the settings, so that they can be copied to other audio ports connected to the same type of donor radio 125.

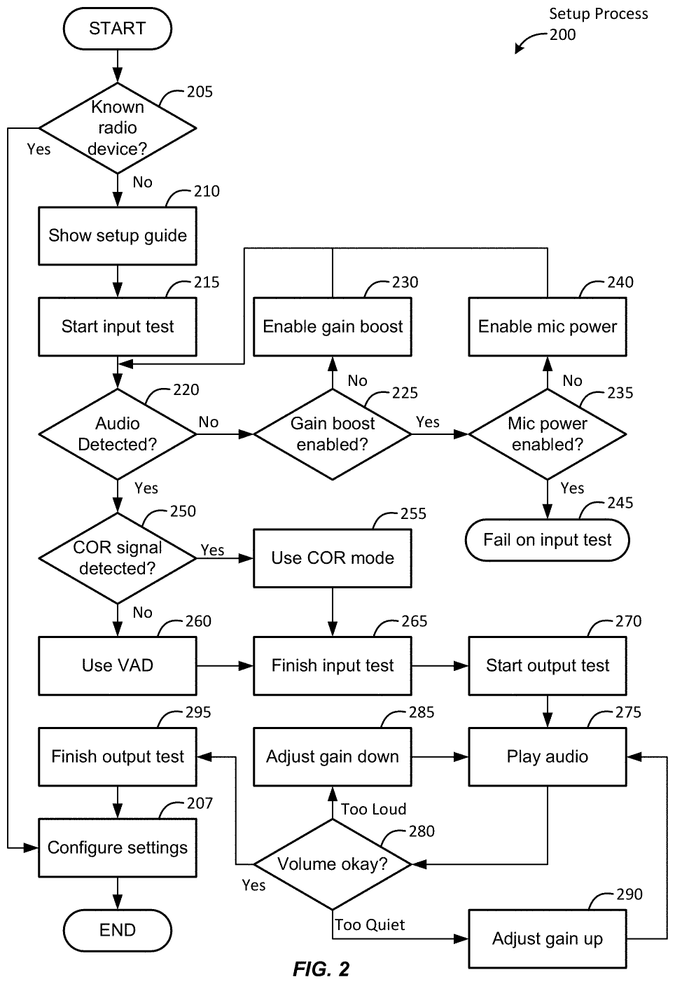

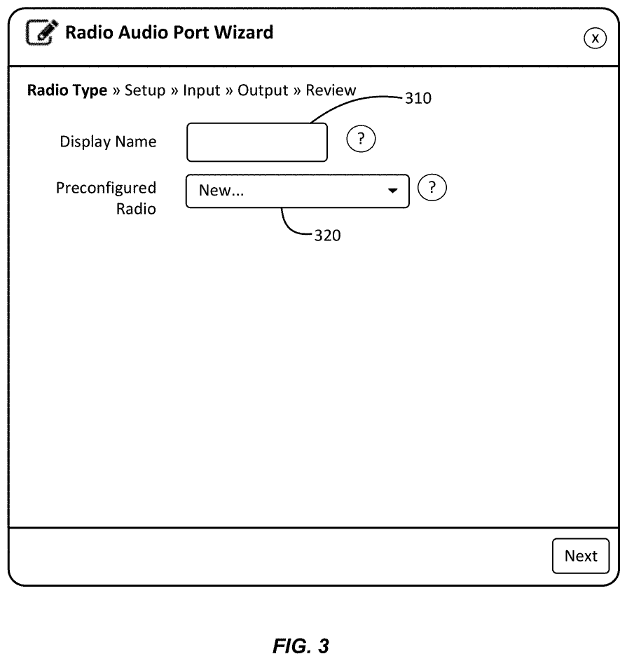

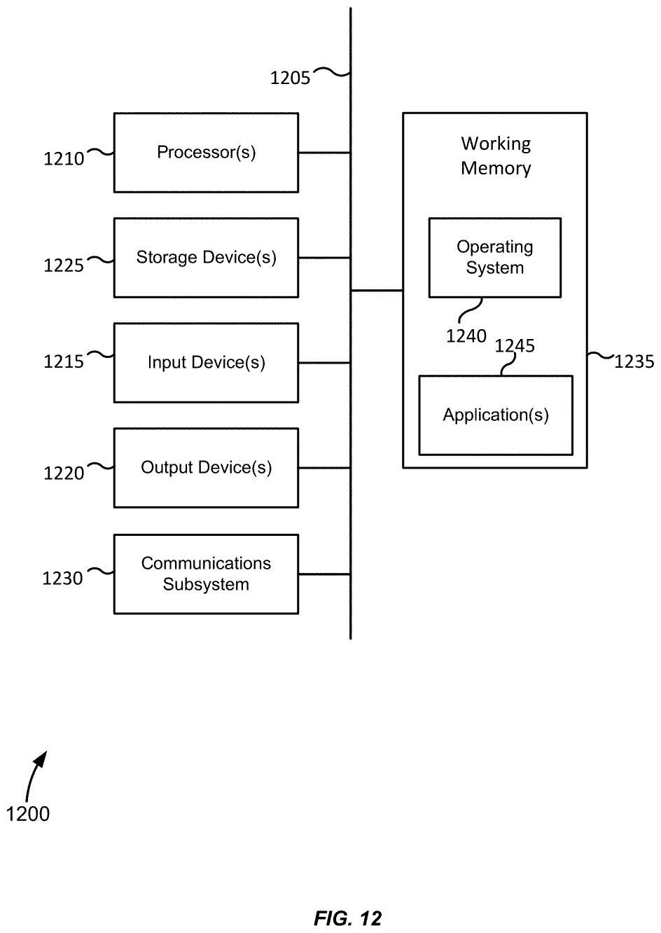

FIG. 2 is a flow chart of a set up process 200 that can be executed by a RoIP gateway device 110 to set up an audio port for use with a donor radio 125, according to an embodiment. It can be noted that, in alternative embodiments, the functionality illustrated in the various blocks shown in FIG. 2 may be executed at different times. That is, in alternative embodiments, the blocks in FIG. 2 may be rearranged, combined, separated, or otherwise altered. Means for performing the various functions illustrated in FIG. 2 can include hardware and/or software components of the RoIP gateway device 110, such as those illustrated in FIG. 12 and described in detail below. Additionally, some or all of the setup process 200 may utilize a GUI to lead a user through the setup process 200. Examples of this are provided in the description that follows, in reference to FIGS. 3-10.

The setup process 200 may begin at block 205, where the RoIP gateway device 110 determines whether a donor radio 125 comprises a known radio device. If so, the setup process 200 can bypass audio tests by skipping to functionality at block 207, where the setup process 200 includes configuring settings in a predetermined manner for the known radio device. In some embodiments, default settings for known radio devices can be provided by the manufacturer of the RoIP gateway device 110. That is, the RoIP gateway device 110 may come with settings for popular radio devices preloaded, based on optimal settings for popular radio devices as determined by the manufacturer. Additionally or alternatively, a user may save settings when configuring the RoIP gateway device 110 for use with the particular donor radio 125, and subsequently evoke those settings later, when reconnecting the RoIP gateway device 110 with the same (or similar) donor radio 125. Furthermore, in some embodiments, the software of the RoIP gateway device 110 may be capable of automatically determining the type of donor radio 125.

FIG. 3 is an illustration of a GUI screen that may be shown to a user when setting up an audio port for the RoIP gateway device 110, showing how user input can be used in the determination of whether the radio device is known at block 205 of FIG. 2. This graphical window may be displayed in response to a user selecting, within the GUI, and option to configure a particular audio port.

As shown, the GUI may allow a user to optionally provide a name for audio port in field 310. Additionally or alternatively, the user may optionally use the drop down box 320 select preconfigured settings (e.g., preinstalled by the manufacturer and/or saved settings from the user) for a known device type of the donor radio 125. Depending on radio capabilities, some embodiments may be able to determine a device type automatically, and further automatically pre-populate the drop down box 320 with corresponding preconfigured settings for the determines device type. If there are no preconfigured settings for the device type of the donor radio 125, or if the user would like to create new settings for the donor radio 125, the user may indicate this in the drop-down box 320 (e.g., by selecting “new” as shown in FIG. 3). At any point, a user may select the “X” in the upper right-hand corner to close the graphical window and end the setup process 200. Otherwise, a user may select the “next” button in the lower right-hand corner to proceed.

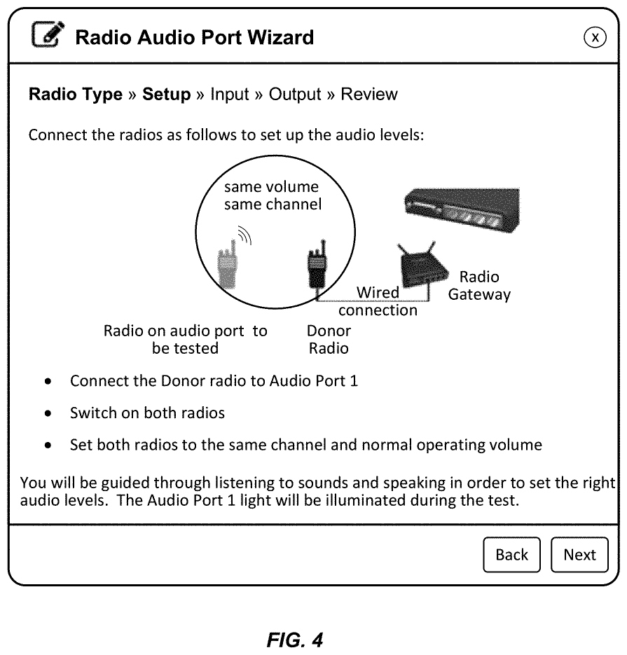

Returning to FIG. 2, if no preconfigured settings are selected by the user, the setup process 200 then proceeds to block 210, where the GUI shows a set up guide to the user. This can be provided in the GUI as one or more screens with graphics and/or text, showing the proper setup between the RoIP gateway device 110, donor radio 125, and separate radio handset 120 for the audio port configuration process. An example of a set up guide provided by a GUI is illustrated in FIG. 4. As shown, the description in the GUI can further indicate to the user what to expect during the rest of the setup process. When the user selects the “next” button on the lower right-hand corner, the setup process 200 can then proceed.

Referring again to FIG. 2, the functionality at block 215 of the setup process 200 comprises starting the input test. The input test comprises implementing the functionality of the setup process 200 shown in blocks 220-265. Generally put, this comprises analyzing input signals (e.g., audio and COR signals) received at the audio port while a user speaks into the radio handset 120 in audio communication with the donor radio 125. This can allow the RoIP gateway device 110 to determine whether voice and/or COR signals from the donor radio 125 are detected at the audio port.

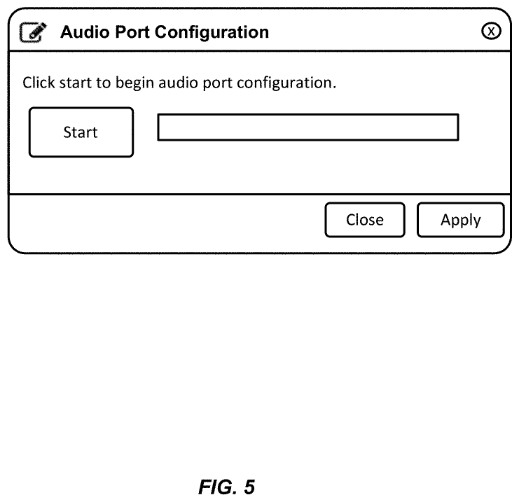

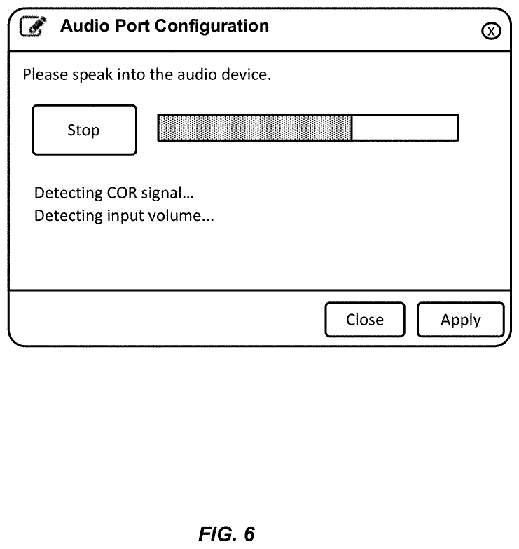

In the GUI, the procedure to conduct the input test may be fairly simple. FIG. 5, for example, illustrates a GUI screen that can allow a user to start the input test once the user is ready by selecting the “start” button. (According to the embodiment shown, the “close” button may allow user to end the audio setup process, and the “apply” button can allow the user to apply audio settings determined after the input test has run.) FIG. 6 is a GUI screen that can appear once the input test has started, prompting the user to speak into the radio handset 120, and indicating the determination of whether input volume and COR signals are detected.

Again, returning to FIG. 2, the functionality of blocks 220-265 indicate what the RoIP gateway device 110 can do during the input test process. At block 220, the RoIP gateway device 110 can determine whether audio is detected at an audio input of the audio port. According to some embodiments, this may comprise simply determining whether the amplitude of a signal detected at the audio input exceeds a minimum threshold value. If communications between the donor radio 125 and the radio handset 120 is properly set up, but the output volume of the donor radio 125 is insufficient, the setup process 200 can then manually or automatically implement gain boost and/or microphone power (e.g., providing power to a connected audio device that may not have its own power supply for the microphone). More specifically, if, at block 220, audio is not detected (e.g., the amplitude of an input audio signal does not exceed a threshold value), the setup process 200 can proceed to block 225, where it is determined whether gain boost is enabled.

If gain boost is not enabled, the RoIP gateway device 110 can enable gain boost for the audio input of the audio port, at block 230, and recheck the audio input to determine whether the signal (after gain boost) meets a threshold value. In some embodiments, enabling gain boost can be done automatically. In other embodiments, the RoIP gateway device 110 can prompt the user for to confirm enabling gain boost before doing so.

If a threshold amount of audio is not detected at the audio input and gain boost is enabled, at block 220, then the process proceeds to block 235, where the RoIP gateway device 110 can determine if microphone power is enabled. If microphone power is not enabled, microphone power can be enabled (again, either automatically or after prompting user input), and the setup process 200 can continue with additional audio detection at block 220. If microphone power is enabled, however, then the input test may fail, as shown at block 245. As indicated in the description below, a failure of the input test may cause the GUI to prompt the user to recheck the connection of the donor radio 125 with the RoIP gateway device 110 and/or conduct other checks.

If, on the other hand, audio is detected, the setup process 200 continues to block 250, where a determination is made whether a COR signal is detected. If COR signal is detected, the RoIP gateway device 110 can enable COR mode, at block 255. Otherwise, it can enable Voice Activity Detection (VAD), at block 260. After enabling COR mode or VAD mode, the RoIP gateway device 110 can then finish the input test, at block 265.

It can be noted that, in alternative embodiments, the setup process may implement similar functionality in a different order. For example, COR signaling at block 250 may be detected prior to or simultaneously with voice detection at block 220. In some embodiments, microphone power may be prioritized over gain boost (such that embodiments enable microphone power prior to enabling gain boost, if needed).

According to some embodiments, rather than providing an automatic gain boost to input audio if the volume of the input audio fails the audio port input test, a user may be provided with volume controls to manually adjust input volume in a manner similar to the adjustment of output volume in the output volume test described herein below. To help facilitate this process, the RoIP gateway device 110 may provide a GUI screen that shows certain audio characteristics of received audio. This can include, for example, whether a certain threshold audio value has been met or exceeded. This not only can help a user determine whether a desired minimum volume has been reached, but can also help the user determine whether audio clipping is occurring due to too much gain. Alternative embodiments may include additional or alternative information regarding the audio.

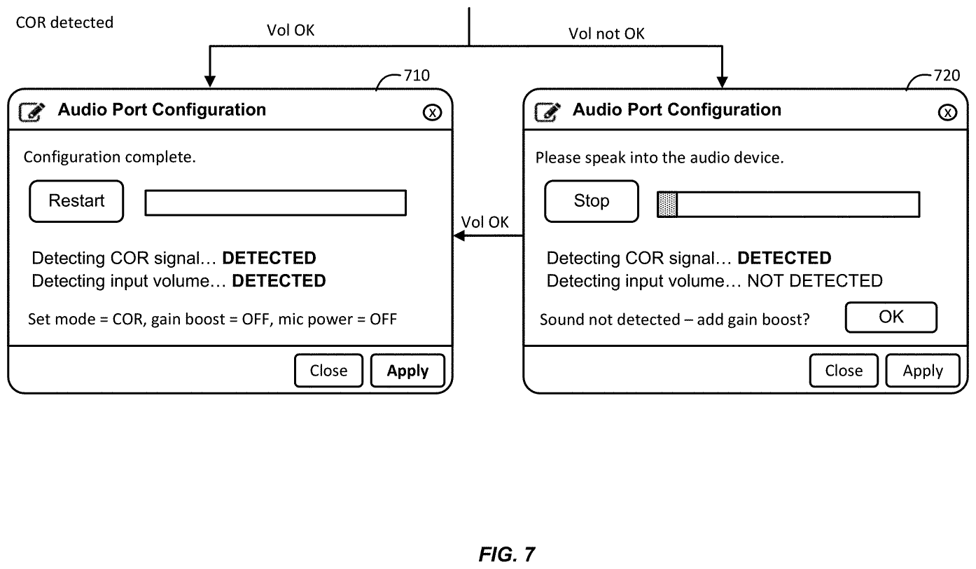

FIGS. 7-10 are illustrations of various GUI screens that can be used during the input testing portion of the setup process 200, according to some embodiments. In each figure, two alternatives are shown, illustrating what the GUI can show to a user following different paths of the setup process 200. In the embodiments illustrated, COR detection (block 250 of FIG. 2) and audio detection (block 220) are conducted during the same input test.

FIG. 7, for example, includes two GUI screens, illustrating what can be shown on the GUI if audio is or is not detected (e.g., at block 220 of FIG. 2), prior to activating gain boost or microphone power. The GUI screen 710 on the left-hand side shows what can be displayed to a user when both input audio and COR signal are detected. In this case, the user may simply select the “apply” button to apply the input audio settings and proceed with the output test. The GUI screen 720 on the right-hand side shows what can be displayed to a user when the COR signal is detected but input audio is not. In this case, the GUI screen 720 allows a user to apply gain boost by selecting the “OK” button, at which point gain boost is enabled (e.g., block 230 of FIG. 2) and the input audio test can determine whether input audio is detected (at block 220) with gain boost enabled. As indicated in FIG. 7, the GUI screen 710 on the left-hand side can then be shown to a user if input audio is then detected.

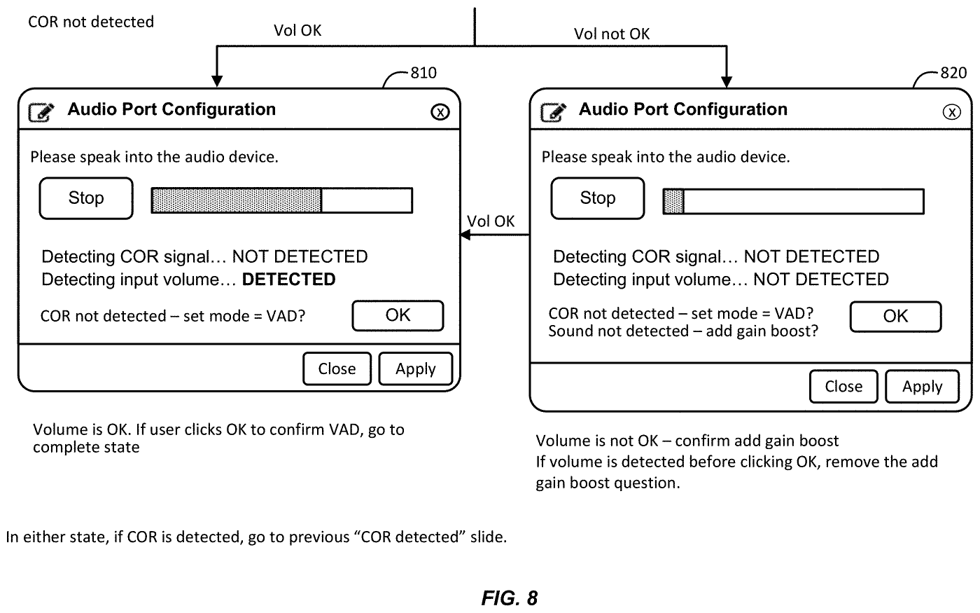

FIG. 8 shows two GUI screens similar to FIG. 7, illustrating what can be shown on the GUI a COR signal is not detected (e.g., at block 250 of FIG. 2), and input volume either is or is not detected. The GUI screen 810 on the left-hand side shows what can be displayed to a user when a COR signal is not detected, but input audio signal is. In this case, the user may select the “OK” button to enable VAD mode. The GUI screen 820 on the right-hand side shows what can be displayed to a user when neither a core signal or input volume is detected. In this case, the GUI screen allows the user to select the “OK” button to enable both VAD and gain boost. As indicated in FIG. 8, the GUI screen 810 on the left-hand side can then be shown to a user if input audio is then detected.

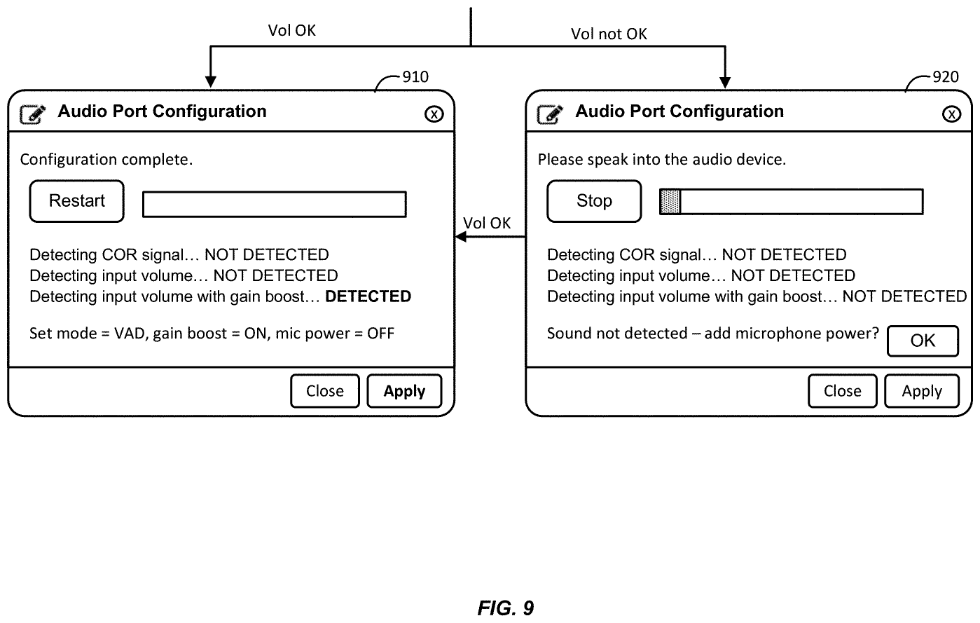

FIG. 9 shows two GUI screens similar to FIGS. 7 and 8, illustrating what can be shown on the GUI if audio is or is not detected (e.g., at block 220 of FIG. 2), after activating gain boost but prior to activating microphone power. The GUI screen 910 on the left-hand side shows what can be displayed to a user when an input audio signal is detected and (a COR signal is not). In this case, similar to FIGS. 7 and 8, the user may simply select the “apply” button to apply the input audio settings and proceed with the output test. The GUI screen 920 on the right-hand side shows what can be displayed to a user when the input audio is not detected (and a COR signal is not). In this case, the GUI screen 920 allows a user to add microphone power by selecting the “OK” button, at which point microphone power is enabled (e.g., block 240 of FIG. 2) and the input audio test can determine whether input audio is detected (at block 220) with both gain boost and microphone power enabled. As indicated in FIG. 9, the GUI screen 910 on the left-hand side can then be shown to a user if input audio is then detected.

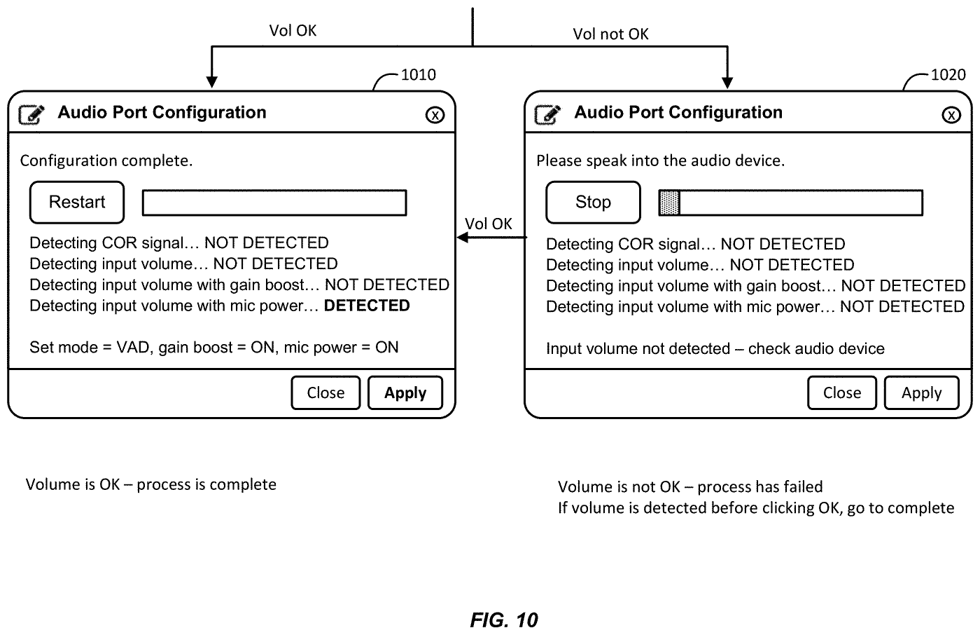

Finally, at FIG. 10 shows two GUI screens similar to FIGS. 7-9, illustrating what can be shown on the GUI if audio is or is not detected (e.g., at block 220 of FIG. 2), after activating both gain boost and microphone power. The GUI screen 1010 on the left-hand side shows what can be displayed to a user when an input audio signal is detected and (a COR signal is not). In this case, the user may simply select the “apply” button to apply the input audio settings and proceed with the output test. The GUI screen 1020 on the right-hand side shows what can be displayed to a user when the input audio is not detected (and a COR signal also is not). In this case, the GUI screen 1020 indicates to the user that input volume is not detected and to check the audio device. As indicated in FIG. 10, the GUI screen 1010 on the left-hand side can then be shown to a user if input audio is then detected.

Returning to FIG. 2, once the input test is completed, the output test may be started at block 270. Here again, the GUI may provide one or more screens on the display to guide the user through the process including an initial screen with the button to start the process, for example.

At block 275, the RoIP gateway device 110 can provide an audio signal at an audio output of the audio port. If connected correctly, the donor radio 125 will communicate the output audio signal (via RF communication) to the radio handset 120 being used in the setup process 200. The audio signal provided by the RoIP gateway device 110 may comprise a tone or prerecorded message (e.g., containing voice audio).

At block 280, it can be determined whether the volume is acceptable, too loud, or too quiet. Here, whether the volume is satisfactory may be a subjective measure by the user. If the volume is too loud or too soft, the user can then use options available within the GUI to decrease (at block 285) or increase (block 290) the output audio gain of the audio port, respectively. Through an iterative process of conducting the audio port output test and adjusting the volume, the user can eventually adjust the output volume of the audio ports to a subjectively satisfactory volume, at which point the output test can be finished (at block 295). Once finished, setup process 200 can move to block 207, where the settings of the RoIP gateway device 110 are configured in accordance with the test results, and the setup process 200 is complete.

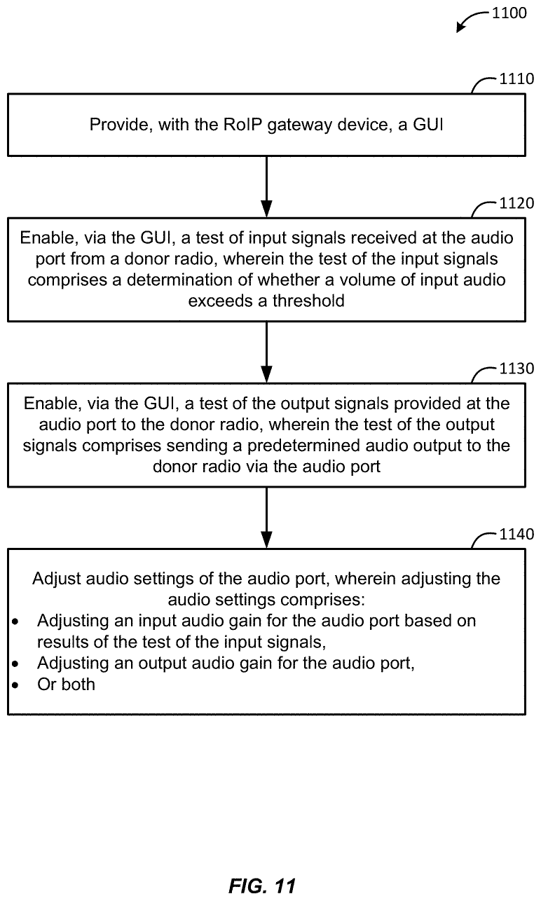

FIG. 11 is a flow diagram of a method 1100 of configuring an audio port for a RoIP gateway device 110, according to an embodiment. The method 1100 can be seen as one way of implementing aspects of the setup process 200 illustrated in FIG. 2. Means for performing one or more of the functions illustrated in FIG. 11 may comprise hardware and/or software components of a RoIP gateway device 110, such as those illustrated in FIG. 12 and described in more detail below.

The method can begin at block 1110, where the functionality includes providing a GUI with the RoIP gateway device 110. As noted in the embodiments described above, a RoIP gateway device 110 may not itself comprise a display capable of showing a GUI. However, according to some embodiments, the RoIP gateway device 110 may be capable of providing a GUI via a webpage accessible via an electronic device (with the display) communicatively coupled with the RoIP gateway device (e.g., via the Internet). Additionally or alternatively, the RoIP gateway device may have a display output to which a display may be coupled, along with inputs for amounts and/or keyboard, enabling display of and interaction with the GUI.

The functionality at block 1120 comprises enabling, via the GUI, a test of input signals received at the audio port from a donor radio. Here, the test of the input signals comprises a determination of whether a volume of input audio exceeds a threshold. As previously described, input signals to the RoIP gateway device 110 may comprise audio and (optionally) COR signals from the donor radio. As further noted above, in some embodiments, the test of input signals further comprises a determination of whether COR signaling is detected. If so, the settings of the RoIP gateway device 110 can be configured for COR operation. If not, the settings of the RoIP gateway device 110 can be configured for VAD operation.

As noted in the embodiments above, gain boost and/or microphone power can be used if the volume of the input audio does not exceed a minimum threshold. That is, embodiments of the method 1100 may further comprise, in response to a determination that the volume of the input audio does not exceed the threshold, enabling a gain boost. A test of the volume of the input audio with the gain boost enabled can then be conducted. In some embodiments, the method 1100 may further comprise determining, from the test of the volume of the input audio with the gain boost enabled, that the volume of the input audio does not exceed the threshold. In this instance, in response to the determination that the volume of the input audio with the gain boost enabled does not exceed the threshold, embodiments may further comprise adjusting a microphone power and conducting test of the volume of input audio with the adjustment in microphone power.

As noted, some embodiments may provide the user with a visual representation, within the GUI, of the input audio signals. This can allow the user to make a determination of whether or not to adjust input audio settings. This can include determining whether the input audio is clipping. Thus, in some embodiments, the method 1100 may further comprise providing, with the GUI, a visual representation of the input signals, indicative of an amplitude of the input signals relative to a maximum input amplitude.

At block 1130, the functionality includes enabling, via the GUI, a test of the output signals provided at the audio port to the donor radio. The test of the output signals comprises sending a predetermined audio output to the donor radio via the audio port. As noted, the predetermined audio output may comprise a tone or prerecorded message (e.g., a voice message), which may be stored as a prerecorded audio file on the RoIP gateway device 110.

At block 1140, the method 1100 includes adjusting audio settings of the audio port. Here, adjusting the audio settings comprises adjusting and input audio gain for the audio port based on results of the test of the input signals, adjusting an output audio gain for the audio port, or both. Here, the adjustment of the output audio may be based on subjective user input. Accordingly, according to some embodiments, the method 1100 may further comprise adjusting again for output audio of the audio port in response to user input.

FIG. 12 is a block diagram of simplified computer system 1200, according to some embodiments of the present disclosure. A computer system 1200 as illustrated in FIG. 12 may, for example, function as and/or be integrated into a RoIP gateway device 110, a PC executing software to emulate the functionality of a RoIP gateway device 110, and/or other devices as described herein. FIG. 12 provides a schematic illustration of one embodiment of a computer system 1200 that can perform some or all of the steps of the methods provided by various embodiments. It should be noted that FIG. 12 is meant only to provide a generalized illustration of various components, any or all of which may be utilized as appropriate. FIG. 12, therefore, broadly illustrates how individual system elements may be implemented in a relatively separated or relatively more integrated manner.

The computer system 1200 is shown comprising hardware elements that can be electrically coupled via a bus 1205, or may otherwise be in communication, as appropriate. The hardware elements may include one or more processors 1210, including without limitation one or more general-purpose processors (e.g., CPUs) and/or one or more special-purpose processors such as digital signal processing chips, graphics acceleration processors (e.g., GPUs), and/or the like; one or more input devices 1215, which can include without limitation a mouse, a keyboard, a camera, and/or the like; and one or more output devices 1220, which can include without limitation a display device, a printer, and/or the like.

The computer system 1200 may further include and/or be in communication with one or more non-transitory storage devices 1225, which can comprise, without limitation, local and/or network accessible storage, and/or can include, without limitation, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The computer system 1200 might also include a communication subsystem 1230. For a computer subsystem 1200 comprising a RoIP gateway device 110, the communications subsystem may comprise one or more audio ports, one or more Universal Serial Bus (USB) ports, and a communication interface to enable the RoIP gateway device 110 to communicate with a media server, SIP PBX, and/or other remote devices and/or networks. As such, the communications subsystem 1230 may comprise without limitation a modem, a network card (wireless or wired), an infrared communication device, a wireless communication device, and/or a chipset, and/or the like.

The computer system 1200 also can include software elements, shown as being currently located within the working memory 1235, including an operating system 1240, device drivers, executable libraries, and/or other code, such as one or more application programs 1245, which may comprise computer programs provided by various embodiments (e.g., a web server, core software, etc.), and/or may be designed to implement methods, and/or configure systems, provided by other embodiments, as described herein. Merely by way of example, all or part of one or more procedures described with respect to the methods discussed above (e.g., the method 1100 of FIG. 11), and/or methods described in the claims, might be implemented as code and/or instructions executable by a computer and/or a processor within a computer. In an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 1225 described above. In some cases, the storage medium might be incorporated within a computer system, such as computer system 1200. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 1200 and/or might take the form of source and/or installable code, which, upon compilation and/or installation on the computer system 1200 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 1200 to perform methods in accordance with various embodiments of the technology. According to a set of embodiments, some or all of the procedures of such methods are performed by the computer system 1200 in response to processor(s) 1210 executing one or more sequences of one or more instructions, which might be incorporated into the operating system 1240 and/or other code, such as an application program 1245, contained in the working memory 1235. Such instructions may be read into the working memory 1235 from another computer-readable medium, such as one or more of the storage device(s) 1225. Merely by way of example, execution of the sequences of instructions contained in the working memory 1235 might cause the processor(s) 1210 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 1200, various computer-readable media might be involved in providing instructions/code to processor(s) 1210 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 1225. Volatile media include, without limitation, dynamic memory, such as the working memory 1235.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of +20% or +10%, +5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of +20% or +10%, +5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A method of configuring an audio port for a RoIP gateway device, the method comprising:
providing, with the RoIP gateway device, a Graphical User Interface (GUI);
enabling, via the GUI, a test of input signals received at the audio port from a donor radio, wherein the test of the input signals comprises a determination of whether a volume of input audio exceeds a threshold;
enabling, via the GUI, a test of output signals provided at the audio port to the donor radio, wherein the test of the output signals comprises sending a predetermined audio output to the donor radio via the audio port; and
adjusting audio settings of the audio port, wherein adjusting the audio settings comprises:
adjusting an input audio gain for the audio port based on results of the test of the input signals,
adjusting an output audio gain for the audio port,
or both.

2. The method of claim 1, wherein the test of the input signals further comprises a determination of whether (Carrier Operated Relay) COR signaling is detected.

3. The method of claim 2, further comprising configuring the RoIP gateway device for COR signaling responsive to determining COR signaling is detected.

4. The method of claim 2, further comprising configuring the RoIP gateway device for Voice Activity Detection (VAD) operation, responsive to determining COR signaling is not detected.

5. The method of claim 1, further comprising:
in response to a determination that the volume of the input audio does not exceed the threshold, enabling a gain boost; and
conducting a test of the volume of the input audio with the gain boost enabled.

6. The method of claim 5, further comprising:
determining, from the test of the volume of the input audio with the gain boost enabled, that the volume of the input audio does not exceed the threshold;
in response to the determination that the volume of the input audio with the gain boost enabled does not exceed the threshold, adjusting a microphone power; and
conducting a test of the volume of input audio with the adjustment in microphone power.

7. The method of claim 1, further comprising providing, with the GUI, a visual representation of the input signals, indicative of an amplitude of the input signals relative to a maximum input amplitude.

8. The method of claim 1, wherein the predetermined audio output comprises a prerecorded audio file.

9. The method of claim 1, further comprising adjusting a gain for output audio of the audio port in response to user input.

10. A Radio over Internet Protocol (RoIP) gateway device comprising:
a memory;
an audio port configured to be communicatively coupled with a donor radio; and
one or more processors communicatively coupled with the memory and the audio port, wherein the one or more processors are configured to:
provide a Graphical User Interface (GUI);
enable, via the GUI, a test of input signals received at the audio port from the donor radio, wherein the test of the input signals comprises a determination of whether a volume of input audio exceeds a threshold;
enable, via the GUI, a test of output signals provided at the audio port to the donor radio, wherein the test of the output signals comprises sending a predetermined audio output to the donor radio via the audio port; and
adjust audio settings of the audio port, wherein adjusting the audio settings comprises:
adjusting an input audio gain for the audio port based on results of the test of the input signals,
adjusting an output audio gain for the audio port,
or both.

11. The RoIP gateway device of claim 10, wherein, to test of the input signals, the one or more processors are configured to determine whether (Carrier Operated Relay) COR signaling is detected.

12. The RoIP gateway device of claim 11, wherein the one or more processors are further configured to configure the RoIP gateway device for COR signaling responsive to determining COR signaling is detected.

13. The RoIP gateway device of claim 11, wherein the one or more processors are further configured to configure the RoIP gateway device for Voice Activity Detection (VAD) operation, responsive to determining COR signaling is not detected.

14. The RoIP gateway device of claim 10, wherein the one or more processors are further configured to:
in response to a determination that the volume of the input audio does not exceed the threshold, enable a gain boost; and
conduct a test of the volume of the input audio with the gain boost enabled.

15. The RoIP gateway device of claim 14, wherein the one or more processors are further configured to:
determine, from the test of the volume of the input audio with the gain boost enabled, that the volume of the input audio does not exceed the threshold;
in response to the determination that the volume of the input audio with the gain boost enabled does not exceed the threshold, adjust a microphone power; and
conduct a test of the volume of input audio with the adjustment in microphone power.

16. The RoIP gateway device of claim 10, wherein the one or more processors are further configured to provide, with the GUI, a visual representation of the input signals, indicative of an amplitude of the input signals relative to a maximum input amplitude.

17. The RoIP gateway device of claim 10, wherein the one or more processors are further configured to adjust a gain for output audio of the audio port in response to user input.

18. A non-transitory computer-readable medium having instructions embedded thereon for configuring an audio port for a Radio over Internet Protocol (RoIP) gateway device, wherein the instructions, when executed by one or more processors, cause the one or more processors to:
provide a Graphical User Interface (GUI);
enable, via the GUI, a test of input signals received at the audio port from a donor radio, wherein the test of the input signals comprises a determination of whether a volume of input audio exceeds a threshold;
enable, via the GUI, a test of output signals provided at the audio port to the donor radio, wherein the test of the output signals comprises sending a predetermined audio output to the donor radio via the audio port; and
adjust audio settings of the audio port, wherein adjusting the audio settings comprises:
adjusting an input audio gain for the audio port based on results of the test of the input signals,
adjusting an output audio gain for the audio port,
or both.

19. The non-transitory computer-readable medium of claim 18, wherein, to test of the input signals, the instructions, when executed by one or more processors, cause the one or more processors to further determine whether (Carrier Operated Relay) COR signaling is detected.

20. The non-transitory computer-readable medium of claim 18, wherein the instructions, when executed by one or more processors, further cause the one or more processors to:
in response to a determination that the volume of the input audio does not exceed the threshold, enable a gain boost; and
conduct a test of the volume of the input audio with the gain boost enabled.
